(19) United States
(12) Patent Application Publication
(10) Pub. No.: US 2014/0299646 A1
(43) Pub. Date: Oct. 9, 2014

(54) HAND HELD POWER TOOL FOR DRIVING FASTENERS

(71) Applicant: POLY SYSTEMS PTY LTD, George Town (AU)

(72) Inventor: Roger Clyde Webb, George Town (AU)

(21) Appl. No.: 14/351,043

(22) PCT Filed: Oct. 10, 2012
(86) PCT No.: PCT/AU2012/001227

§ 371 Date: Apr. 10, 2014

(30) Foreign Application Priority Data
Oct. 13, 2011 (AU) 2011904223

(51) Int. Cl. B25C 1/08

(52) U.S. Cl. CPC B25C 1/08
USPC 227/10

(57) ABSTRACT

A hand-held power tool powered by a gas combustion mechanism comprising a combustion chamber, a second chamber within a cylinder having aft and fore ends. The combustion chamber in fluid communication with the second chamber, and a first supercharger including a driver assembly, a drive motor and a fan assembly, the driver assembly having a piston and driver movable within the cylinder between said aft and fore ends. In use, whilst the piston is at or near the fore end of the cylinder, the fan assembly introduces air into the combustion chamber and the second chamber thereby pressuring the air there within, and fuel gas is introduced into the combustion chamber from a first supply port, the air and fuel gas becoming an air/fuel gas mixture therein. The drive motor moves the piston to a position at or near the aft end thereby compressing the air/fuel gas mixture within the first combustion chamber so that it is ignites within the combustion chamber to impart motion onto the piston. A second supercharger is connected to the combustion chamber for supplying a fuel gas and air mixture from a second supply port.

### TECHNICAL FIELD

The present invention relates to an internal combustion fastener driving tool.

### BACKGROUND

Fastener driving tools have been developed that use internal combustion as a power source to drive fasteners such as nails, pins and staples into a work piece or substrate made of wood, concrete or steel. The tools ignite a fuel/air mixture in a combustion chamber to forcibly drive a piston, which then ejects the fastener from the tool. The effectiveness of the prior art is largely limited to their efficiency in rapidly igniting the complete volume of fuel/air mixture. If insufficient volumes of fuel ignite, the device delivers unsuitable driving forces to the fastener. If the tool produces unreliable power outputs the fasteners may be driven to unsatisfactory depths or insufficiently seated. Prior art devices have attempted to address these inefficiencies by making a larger tool and wasting larger volumes of fuel.

Some prior art tools also suffer from what is known as misfire (or non-fire). This occurs when the tool is operated in low temperature conditions or at high altitude and hot conditions. The cause of the phenomenon is; (a) insufficient atomization and mixing of the air/fuel; (b) an insufficient fuel/air ratio; (c) low air density.

One such prior art tool is described in U.S. Pat. No. 5,213,247 (Gschwend et al). This device includes a network of mechanisms that operate to measure a specific quantity of fuel and then draw that fuel, along with air, into a combustion chamber by mechanically expanding the combustion chamber volume. A drawback of this device is that the fuel and gas are not mixed sufficiently, which decreases the efficiency of combustion.

A further disadvantage of such prior art tools is the tool mass (weight and physical size) required for a given output of energy. Furthermore, such tools draw fuel and air into the combustion chamber with partial vacuum. As a consequence the fuel/air mixture is ignited at a low pressure, which leads to a low burn rate and further inefficiency. This is particularly problematic in that the less efficient an internal combustion fastener driving tool is, the more susceptible the device is to output fluctuations that result in ignition failures and unsatisfactory driving forces to the fastener.

Also prior art impulse tools such as those used in nail and fixing in the building industry have limitations in their use. Such tools have the capability of producing 70 to 100 joules of output energy. These tools will only produce their manufactured claimed output under optimal conditions ie; 24C@sea level and a relevant humidity level of approximately 40%. If these optimum conditions change, so does the power output by as much as 25%, and in some cases they do not fire at all. This means that nails and fixers sometimes protrude and are only driven 80 to 90% of the manufactured depth, and thus the work piece may not meet building standards. This may also lead the operator to have to use a traditional hammer to finish the job.

Some impulse tool manufactures have developed tools to produce in excess of 100 joules, but such tools have ended up being a far larger unit for consumers to reasonably expect to purchase.

All prior art combustion tools used for fixing, suffer from gumming up and need to be cleaned regularly. This is caused by incomplete combustion in the tool. Carbon, lubricants and other bi-products of combustion and exhaust gases build up deposits within the combustion chamber, driver piston and head.

A new and more powerful generation of cordless combustion impulse tools employing “supercharging” in their combustion processes have been developed. One such tool is described in our International Publication No. WO 2009/140728 (International Application No. PCT/AU2009/000629).

Whilst the supercharged tools are more powerful than earlier prior art tools, they suffer from a number of disadvantages.

Firstly there is a higher demand on battery power availability, resulting in less tool cycles per battery charge.

Secondly inefficiencies with ignition processes may result in an incomplete burn.

Thirdly, an unregulated fuel delivery system may result in an incorrect fuel ratio which may cause the tool to misfire (or non-fire). This occurs when the tool is operated in low temperature conditions or at high altitude and hot conditions. The cause of the phenomenon is insufficient atomization and mixing of the air/fuel and or an insufficient fuel/air/supercharging ratio.

Fourthly, energy output and duration and energy fluctuations can be a disadvantage. In the prior art supercharged tools, a large amount of energy is created at the beginning (first 50%) of the driving stroke as opposed to the ending (latter 50%) of the driving stroke where a greater frictional force is acting on the nail or pin.

The tool cycle time has been extended from 4 cycles per second to 2, as a result of the time delay created by the supercharging time delay.

With these new technology's and higher outputs a larger tool is resulting. Supercharging pressures and tool output power are limited to the ability of the driver piston holding mechanism in conjunction with the driver piston return mechanism and overall tool construction.

High output supercharging of cordless combustion impulse tools has also created new and in some cases catastrophic part overstress, failures and overheating. It has also been found that the internal circulation fan drive motor can fail due to the increase in ignition pressures and/or shock within a super-charged system.

The present invention seeks to provide a fastener driving tool that will ameliorate or overcome at least one of the deficiencies of the prior art.

### SUMMARY OF INVENTION

According to a first aspect the present invention consists in a hand-held power tool, the operational power of which is provided by a gas combustion mechanism, said gas combustion mechanism comprising a first combustion chamber, a second chamber within a driving cylinder having an aft end and a fore end, said first combustion chamber in fluid communication with said second chamber via said aft end, a first supercharger including a driver assembly, a drive motor and at least one fan assembly, said driver assembly having a piston and driver movable within said driving cylinder between said aft end and said fore end, said drive motor operably connected to said driver assembly, wherein in use, whilst said piston is at or near said fore end of said driving cylinder, said fan assembly introduces air into said first combustion chamber and said second chamber thereby at least partially pressuring the air there within, fuel gas is introduced into said combustion chamber from a first fuel supply port, the air and fuel gas being mixed to form an air/fuel gas mixture therein, said drive motor operably moves said piston to a position at or near said aft end thereby compressing said air/fuel gas mixture within said first combustion chamber so that said air/fuel mixture is ignited within the combustion chamber to impart motion onto said piston and to facilitate the operation of the tool, characterized in that a second supercharger is operably connected to said combustion chamber for supplying a fuel gas and air mixture from a second supply port.

Preferably both the first supercharger and second supercharger can be used in combination or independently to each other to supercharge said tool.

Preferably fuel from said second supply port is a weaker fuel than the fuel being dispensed from said first supply port.

Preferably fuel from said second supercharger cylinder may be introduced into said combustion chamber after or during ignition of fuel and air mixture supercharged by said first supercharger.

Preferably said tool further comprises a movable tool nose assembly and a trigger assembly both operably connected to an ECM for the control and actuation of the fan assembly, drive motor and first and second gas supply ports.

Preferably said tool has a selector switch operably connected to said ECM that allows said a user to select operation of said first supercharger and second supercharger to be used in combination or independently to each other.

Preferably said ECM includes a programmed timing circuit to allow variation of the supercharging provided by said second supercharger to engage and disengage said secondary supercharger and also vary the amount of supercharging from said first supercharger.

Preferably said second supercharger comprises a double acting cylinde

Preferably said driving cylinder is directly connected to a cylinder head that supports said fan assembly.

Preferably said driving cylinder has plurality of radially spaced apart inlet primary inlet ports around the driving cylinder near cylinder head, and a plurality of secondary transfer polarity ports radially spaced apart around said driving cylinder at a location further away from cylinder head and extending below annular chamber housing.

Preferably an annular chamber housing surrounding said driving cylinder and connected thereto allows for a portion of said combustion chamber to extend radially beyond the external diameter of said driving cylinder.

Preferably said fan assembly has a first external induction fan for introducing air into said first combustion chamber.

Preferably said fan assembly has a fan motor which is of a pancake type.

Preferably said fan assembly has a second internal circulation fan disposed within said first combustion chamber.

Preferably said second internal circulation fan is in magnetic communication with a second drive motor.

### BRIEF DESCRIPTION OF DRAWINGS

FIG. 1 shows a schematic cross-sectional view of a hand held internal combustion nail fastener tool in accordance with a first embodiment of the present invention;

FIG. 2a shows a schematic cross-sectional view of the hand held internal combustion nail fastener tool of FIG. 1 and the air flow paths as air is introduced into the combustion chamber for charging using the primary supercharger.

FIG. 2b shows a schematic cross-sectional view of the hand held internal combustion nail fastener tool of FIG. 1 and the air flow paths as air is introduced into the combustion chamber for charging using the primary supercharger.

FIG. 3 shows a schematic cross-sectional view of the hand held internal combustion nail fastener tool of FIG. 2 with the driver and piston in a fully extended position where the piston abuts and compresses the bumper as a result of the firing trigger being fully depressed and air/fuel mixture being ignited;

FIG. 4 shows a schematic cross-sectional view of the hand held internal combustion nail fastener tool of FIG. 1 in the mode when a user has touched the trigger, thereby causing external air to be force fed (supercharged via primary supercharger) into the combustion and drive cylinder chambers and the piston has been driven to a positioning abutting the bumper and blocking the exhaust port;

FIG. 5 shows a schematic cross-sectional view of the hand held internal combustion nail fastener tool of FIG. 1 placed against the substrate and ten percent travel of the movable tool nose has occurred;

FIG. 6 shows a schematic cross-sectional view of the hand held internal combustion nail fastener tool of FIG. 1 placed against the substrate and one hundred percent travel of the movable tool nose has occurred;

FIG. 7 shows a schematic cross-sectional view of the hand held internal combustion nail fastener tool of FIG. 1 placed against the substrate and the firing trigger been activated about ten percent of its travel;

FIG. 8 shows an enlarged schematic cross-sectional view of the top end (combustion chamber/fan assembly end) of the hand held internal combustion nail fastener tool of FIG. 1.

FIG. 9 shows an enlarged side view detail of the two fuel cells and secondary supercharger of the hand held internal combustion nail fastener tool of FIG. 1.

FIG. 10 shows an enlarged schematic cross-sectional view of the top end of the hand held internal combustion nail fastener tool of FIG. 1, with internal components extending into combustion chamber omitted to clearly indicate combustion chamber location.

FIG. 11 is a typical graph representation of Output Energy (kgf/cm2) Vs Time (ms) that would be achieved relying on primary supercharging producing 70 joules of output energy.

FIG. 12 is a typical graph representation of Output Energy (kgf/cm2) Vs Time (ms) that would be achieved relying on primary supercharging producing 140 joules of output energy.

FIG. 13 is a graph representation of Output Energy (kgf/cm2) Vs Time (ms) that would be achieved relying on primary and secondary supercharging producing a 200 joules of output energy.

### DESCRIPTION OF PREFERRED EMBODIMENTS

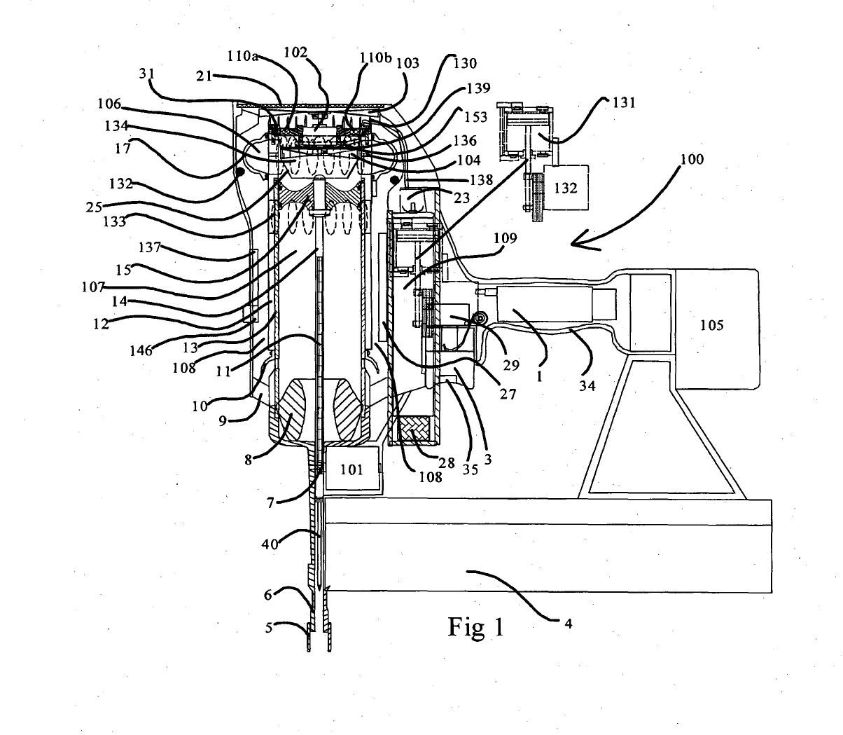

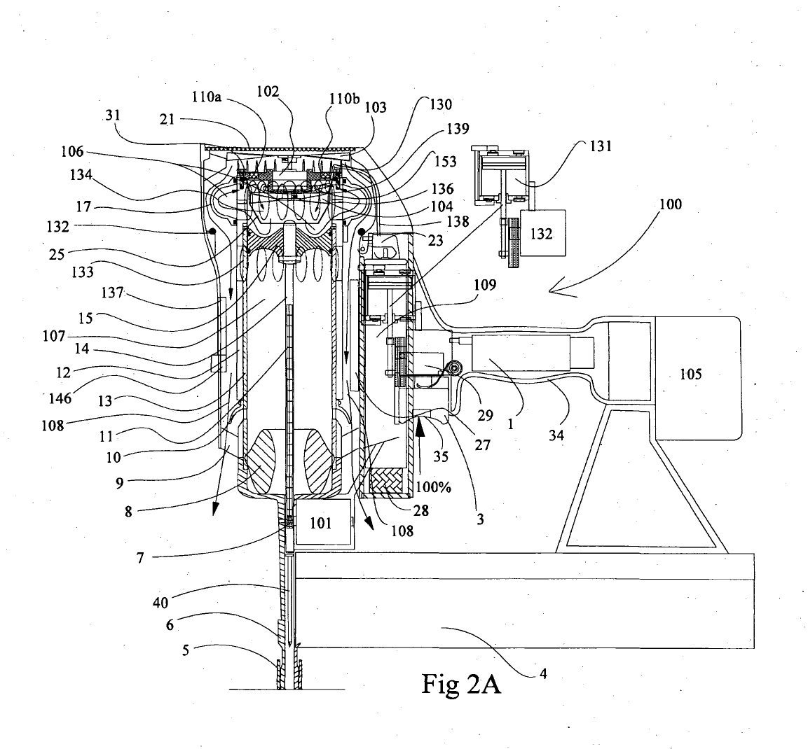

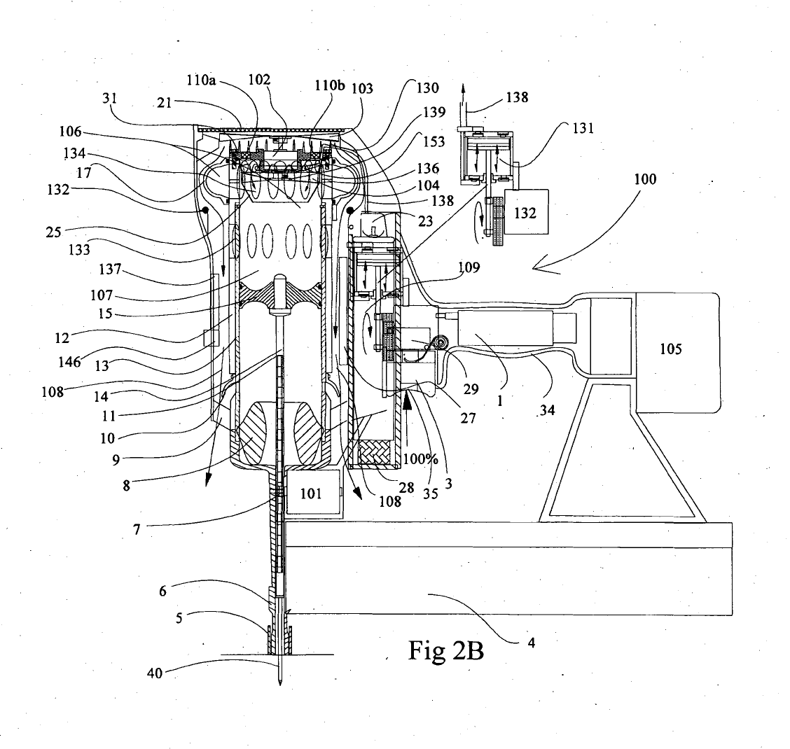

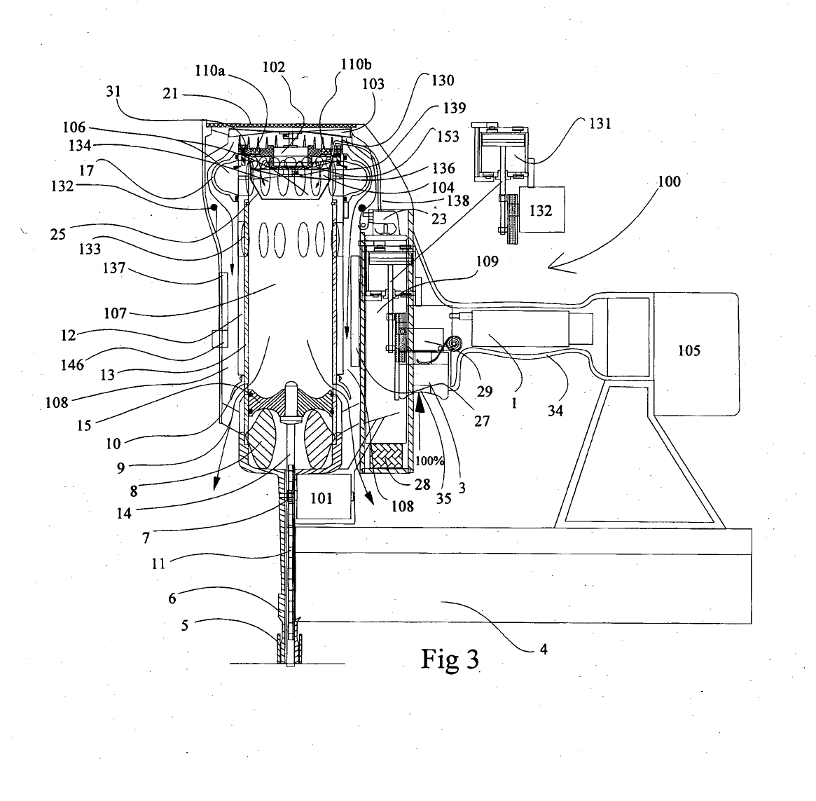

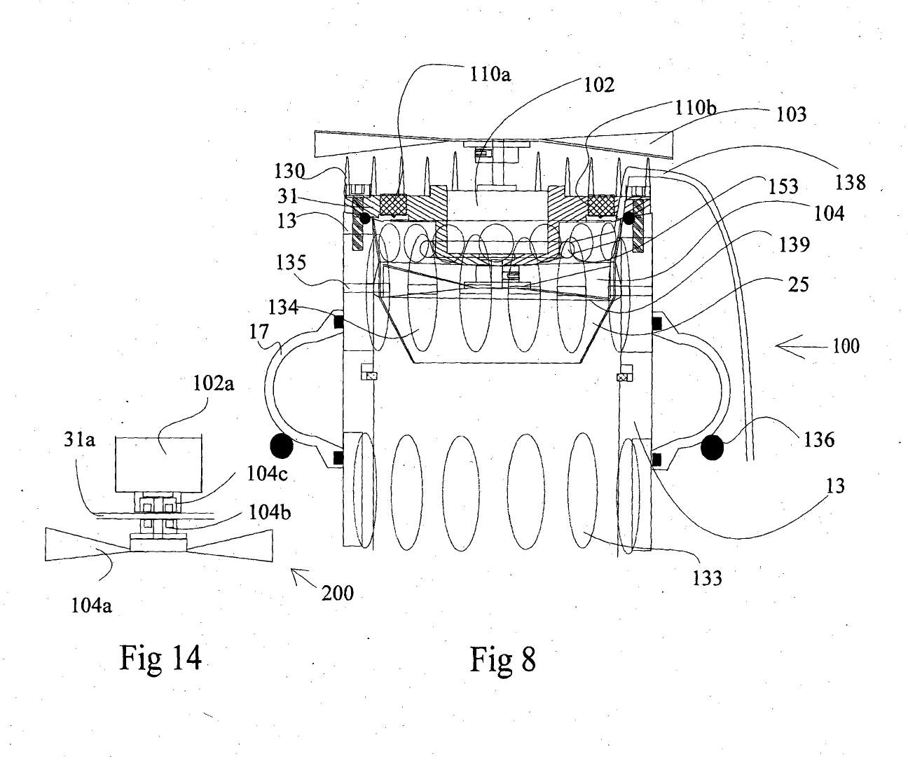

FIGS. 1-10 depict a hand held internal combustion nail fastener tool 100 which includes two superchargers, namely a “primary supercharger” and a “secondary supercharger”.

The first (or primary) supercharger is made up of driver assembly 7, motor 101 and fans 103,104. These components of the first primary supercharger are similar to those shown in our “prior art” International Publication No. WO 2009/140728. Whilst the operation of the “primary supercharger” differs to that of the abovementioned “prior art” tool, for ease of reference those components that are similar in the abovementioned prior art tool are numbered similarly in this embodiment.

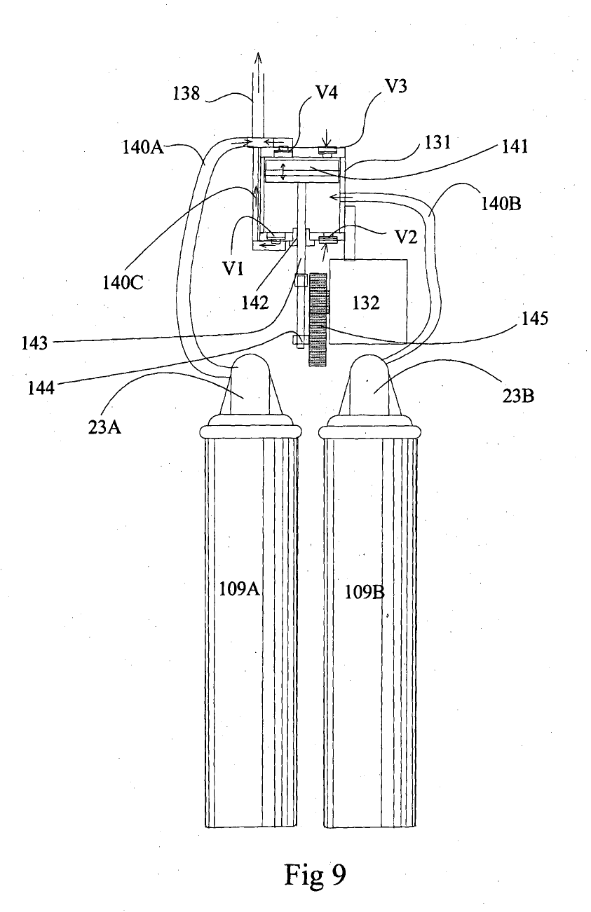

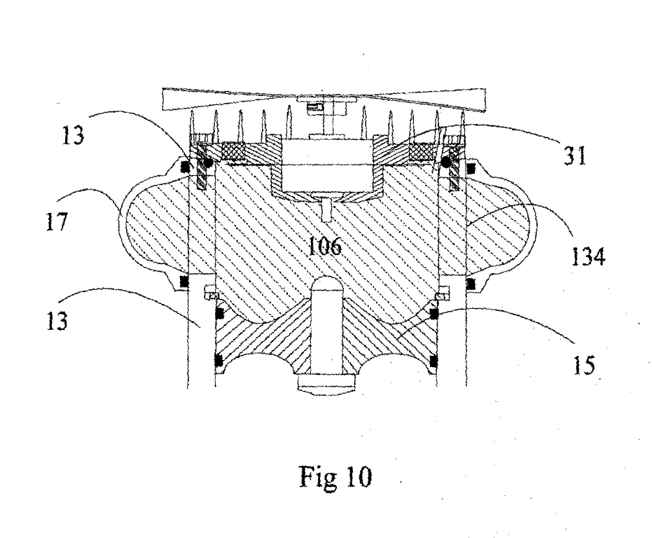

Hand-held internal combustion nail fastener tool 100 comprises a drive motor 101, an induction/circulation motor 102, an external induction fan 103, an internal circulation fan 104, a twenty-four volt battery pack 105, a combustion chamber 106, a driver cylinder chamber 107 within cylinder 13, an exhaust (cooling) cavity 108, a fuel cell cartridge 109a (see FIG. 9), and igniters 110a and 110b. The combustion chamber housing 17 surrounding combustion chamber 106 and mounted to cylinder has a “annular shaped” (best seen in FIG. 10) and is directly mounted to cylinder 13.

Tool 100 has an Electronic Control Module (ECM) 27 which controls various components of tool 100. An output power selector switch 146 connected to ECM 27 allows a user (not shown) to select various operating configurations, “Normal Power” (only primary supercharger employed), “High Power” (both primary and secondary superchargers employed), and “Low Power” (only secondary supercharger employed).

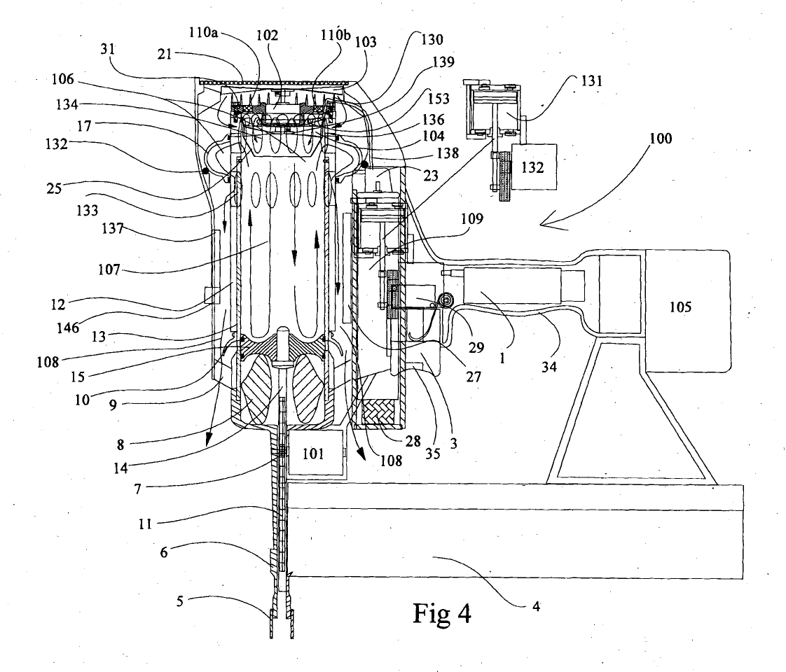

The operation of tool 100 will now be described. A user (not shown) holds tool 100 by support handle (pistol grip) 34. Preferably the user's index finger is placed on firing trigger 3. The touch sensor 35 alerts ECM 27 that tool 100 is to be operated. ECM 27 actuates the electrical circuit to the induction and circulation fan motor 102 to operate at twelve volts. This results in the external induction fan 103 and internal circulation fan 104 to drive air from external of tool 100 in through air intake filter 21. External air is force fed into the combustion chamber 106 via a plurality of inlet ports 134 and driver cylinder chamber 107 (see FIG. 1) has charged air. Simultaneously ECM 27 checks the position of drive motor 101, which is in communication with driver 14 and piston 15 via drive motor gear 7 and driver gear rack 11. The drive motor 101 repositions driver 14 and piston 15 so that the underside of piston 15 is resting on bumper 8, see FIG. 4. In this position the piston 15 is blocking the exhaust port 10 and seals chambers 106 and 107. Also at this same point of the tool cycle the combustion chamber housing 17 is in the one hundred percent (100%) open mode in communication with movable tool nose portion 5. As external air is drawn in via fan 103, seal 132 prevents the air now under pressure from fan 103 from entering cavity 108, so one hundred percent (100%) of external air is directed into the combustion chamber 106. Upon entering combustion chamber 106, the incoming air is further accelerated by the internal circulation fan 104. As the air passes through fan 104, the air is forced to flow through baffle 139 and frusto-conically shaped circulation shroud 25, which further speeds up the air flow. Air is then directed down the centre of driver chamber 107 via shroud 25. At the base of chamber 107 (within cylinder 13), the air flow is split and redirected back up chamber 107 into the combustion chamber 106, via the “toroidally” shaped concave aft surface of piston 15, where the air flow is split by port mask 136 and approximately 95% exits chamber 106 via a plurality of exhaust transfer ports 133, flowing into and along cavity 108 and exiting tool 100 via exhaust vent 9. The remaining air flow in chamber 106 (approximately 5%) flows up to the top of the chamber 106 where it rejoins the incoming air flow through a plurality of holes/vents arranged around the side wall of circulation shroud 25 as seen in FIG. 4.

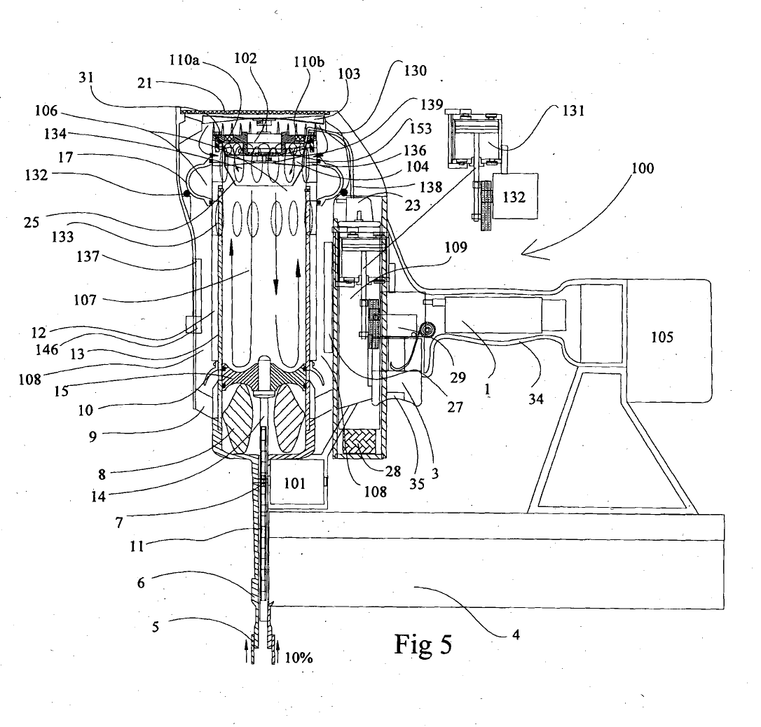

FIG. 5 depicts tool 100 placed onto a substrate where ten percent (10%) travel of movable tool nose portion 5 has occurred. Tool nose portion 5, which is in communication with housing 17, has caused housing 17 to shut off the exhaust transfer ports 133 allowing one hundred percent (100%) of air flow to circulate around chambers 106 and 107. At this same point the ECM 27 has switched motor 102 to twenty-four volts, 200% of the normal manufacturer duty-cycle voltage for motor 102. This causes motor 102 to greatly increase its rotation (rpm) momentarily thus increasing the volume and speed of air flow into chambers 106 and 107, as exhaust port 16 is closed the increase in air flow into chambers 106 and 107 causes an increase in air pressure there within. In prior art impulse tools the exhaust port and air inlet would close off simultaneously, however in this embodiment of the invention, after exhaust ports 133 closes, the increased rotation of motor 102 continues to introduce “supercharged” air into chambers 106 and 107. This is because the closure of exhaust ports 133 is in or near the first ten percent (10%) of travel of housing 17, leaving the inlet side open to receive charged air.

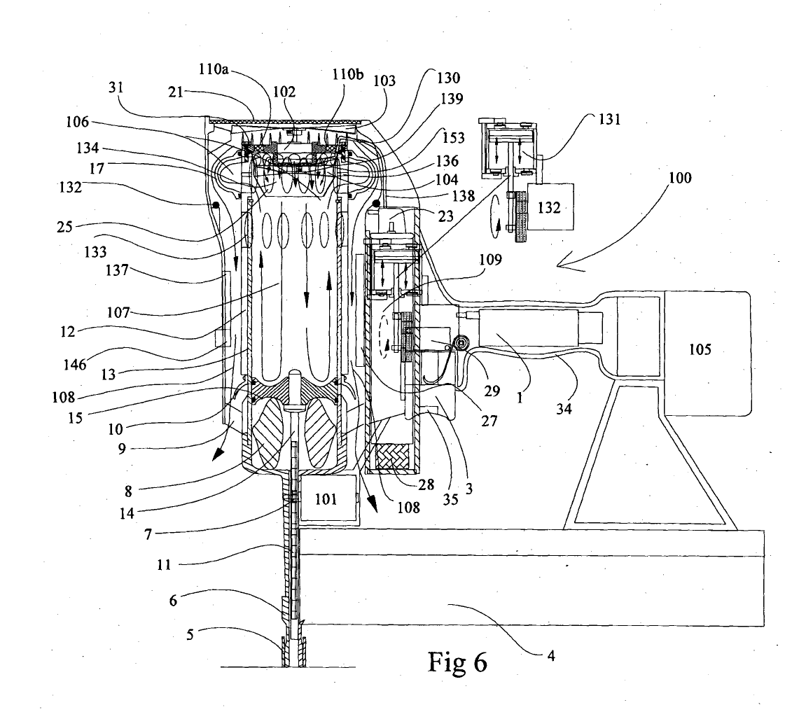

FIG. 6 depicts tool nose 5, in communication with the housing 17, has operated (travelled) at one hundred percent (100%). At this point of the tool cycle, air flow from fan 103 has been redirected into cavity 108. During the last say five percent (5%) of travel of chamber housing 17, seals 17A and 17B cause chambers 106 and 107 to be sealed. When chamber housing 17, has operated (travelled) at one hundred percent (100%) and therefore chambers 106 and 107 are sealed, a metered amount of gas from first fuel cell 109A via gas regulator valve head 23A and gas regulator valve actuator 24, in communication with 17, has entered chamber 106 through jet/manifold 153.

As the fuel exits jet/manifold 153 the rapidly rotating blades of fan 104 accelerate the vaporization and expansion reaction of the fuel gas as well as rapidly circulating and mixing the air and fuel together in chambers 106 and 107.

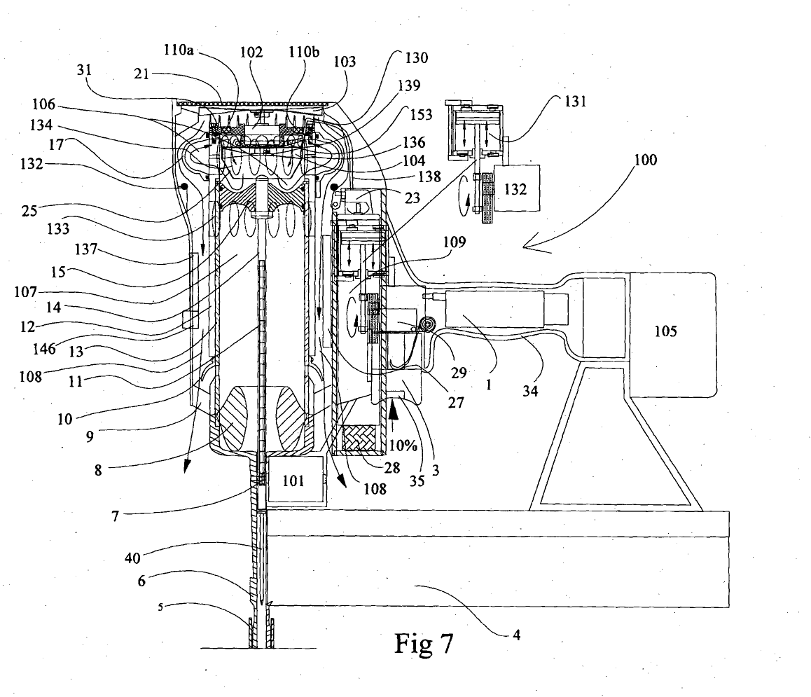

FIG. 7 also depicts that the firing trigger 3 has been actuated ten percent (10%) of its travel. At this point the ECM 27 in communication with trigger 3 switches electrical circuit on to drive motor 101, causing piston 15 and driver 14 in conjunction with rack 11 and gear 7, to travel one hundred percent (100%) to the top of driver cylinder 13. If “High Power” setting is selected via tool output power selector 146, simultaneously ECM 27 switches electrical circuit on momentarily to driver motor 132 and secondary supercharger assembly 131 also delivering air or air/fuel mixture to further boost supercharged pressures.

As chamber 106 is sealed all the air mass in chamber 107 is compressed in to chamber 106, creating a pressure greater than ambient (pressure difference). Also, as the driver assembly 14 and piston 15 achieve one hundred percent (100%) of travel up to the top of cylinder 13, a nail 40 has been placed into the fixed tool nose 6 from fastener magazine 4. Air and fuel now contained in chamber 106 circulates rapidly, shroud 25 directs the fuel/air mixture across the igniters 110a and 110b, by means of vents/holes (not shown) at the base of shroud 25.

FIG. 4 depicts that firing trigger 3 has operated 100% of its travel. ECM 27 switches circuit on to high tension ignition coil 1, thereby operating same very rapidly, at approximately twenty-five to fifty applications. The resulting pulses of high voltage created by the ignition coil 1 are in communication with igniters 110a and 110b. The resulting multiple high-tension sparks from igniters 110a and 110b ignite the fuel/air mixture in combustion chamber 106 simultaneously. ECM 27 switches driver motor 101 to a separate electrical circuit converting driver motor 101 to a generator. As the fuel/air mixture ignites in chamber 106, a rapid rise in pressure occurs forcing the driver assembly 14 and piston 15 down cylinder 13 ejecting nail 40 into the substrate (or work piece). As the driver assembly 14 and piston 15 progresses down cylinder 13 reaches 50% fifty present. If “High Power” setting is selected via tool output power selector 146, ECM 27 switches electrical circuit back on momentarily to drive motor 132 and secondary supercharger 131 to engage for a second time to deliver air/fuel mixture to permit a further secondary supercharged power event to take place . To assist the secondary supercharged power event baffle 139 holds up (interrupts) the incoming air/fuel mixture and separates it from the preceding flame front. The igniters 110a and 110b are then reactivated by ECM 27 resulting in a secondary additional power cycle in the same tool 100 cycle. As the driver assembly 14 and piston 15 progress down the cylinder 13, motor 101 now acting as a generator is in communication with driver assembly 14, via rack 11 and gear 7. The resulting charge is sent back into the battery pack 105, increasing battery/tool cycles between charges. As the driver assembly (driver 14 and piston 15) reach 90% of travel, the underside of piston 15 comes into contact with bumper shock absorber 8, which reduces the kinetic energy of driver 14 and piston 15, bringing them to a steady controlled stop in cylinder 13. At this stage of the tool/combustion cycle the exhaust ports 10 configured in plurality at the base of cylinder 13, are uncovered by piston 15. The exhaust gases in chambers 106 and 107 escape/evacuate through exhaust ports 10, reducing the gas pressure in chambers 106 and 107 to a partial vacuum (lower pressure) than ambient. The stored energy in bumper 8 then repels the driver assembly (driver 14 and piston 15) approximately thirty percent (30%) back up bore 13. ECM 27 then switches fan motor 102 back to normal running mode at 12V. Simultaneously ECM 27 in communication with driver motor 101 checks the position of the driver assembly (driver 14 and piston 15) and adjusts as required, at the bottom of the bore 13 with underside of piston 15 resting on bumper 8 also “closing off” the exhaust ports 10.

Tool 100 is then raised off the substrate allowing movable tool nose portion 5 to extend. Tool nose portion 5 in communication with housing 17 slides forward, allowing air to circulate around 106 and 107 and exit through exhaust ports 16. The firing trigger 3 is then released resetting the ECM 27 back to the start cycle status.

Various features of note of this embodiment will now be discussed in further detail.

It should be noted that as “main” cylinder 13 continues right through tool 100 and connects directly to a more robustly constructed cylinder head 31, tool 100 is more robust. Additionally cooling fins 133 have also been added for additional strength and cooling. These combined features significantly minimize the stresses transmitted through the body which are encountered in the prior art tool of International Publication No. WO 2009/140728. An advantage is that secondary supercharger 131 may also be operated simultaneously with the primary supercharger mechanism for extreme “High Power” output used to drive pins into steel and high density 6000 psi concrete.

A varying degree of “secondary supercharging” is also achieved by having the ability to vary the supercharge pressure by means of a programmed timing circuit within ECM 27 to engage and disengage or turn on and off the double acting secondary supercharger 131 and also vary the amount of supercharging from primary supercharger mechanism, this in turn varies the tool energy output.

To also achieve these overall improvements it is necessary for tool 100 to be equipped with two fuel gas cells 109A, 109B and metering valves 23A and 23B as best seen in FIG. 9. A ‘rich fuel” is preferably delivered directly into the cylinder 13 from “primary” fuel gas cell 109A, via valve 23A, fuel gallery 140A, primary fuel manifold 138 and charge manifold 153. “Secondary” fuel cartridge 109B dispenses a weaker fuel mixture directly into the secondary supercharger 131 via fuel gallery 140B.

To overcome the battery power availability and tool cycle time, the present embodiment employs a secondary supercharger 131 having a modified double acting piston and cylinder mechanism 131 in which improves supercharging time and efficiency by up to 200% by closing off the rear of the cylinder, introducing a bearing/seal 142 for connecting rod 143 to operate within and air inlet valve V2 and outlet valve V1 in conjunction with manifold 140C.

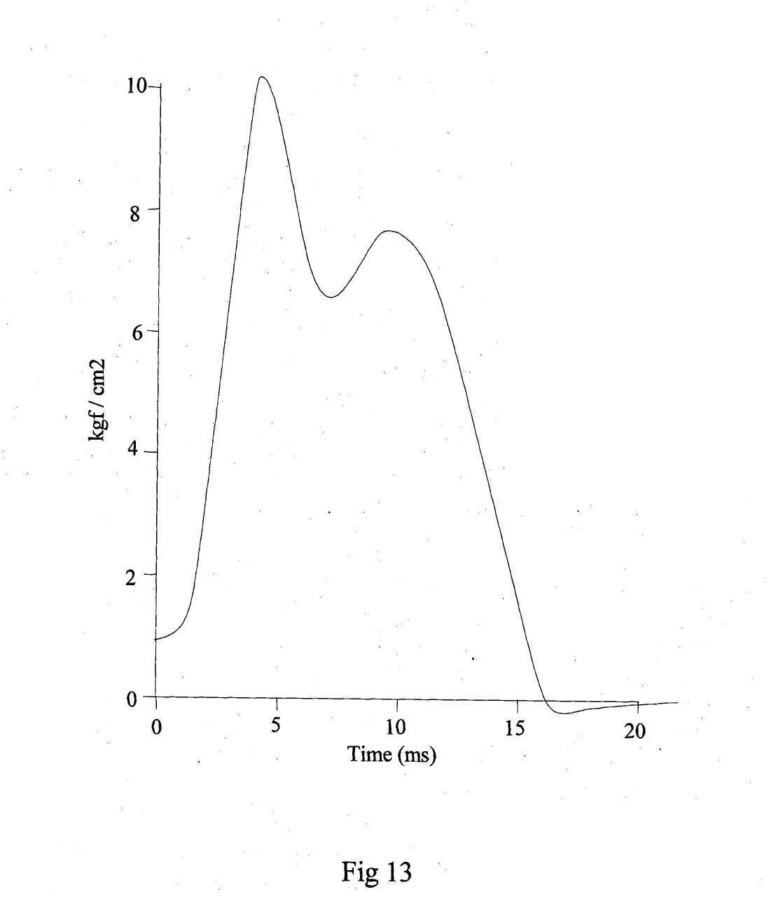

In addition the double acting secondary supercharger 131 having fuel dispensed directly into its cylinder via fuel supply manifold 140B and the secondary fuel cartridge 109B and metering valve 23B can also be re-tasked to operate after the primary combustion cycle, having the ability of achieving a delayed secondary supercharged combustion cycle providing a prolonged power delivery duration as indicated in the “Power Output Vs Time” graph shown in FIG. 13. This delayed secondary supercharged combustion cycle may occur about 4 ms after commencing the primary supercharger.

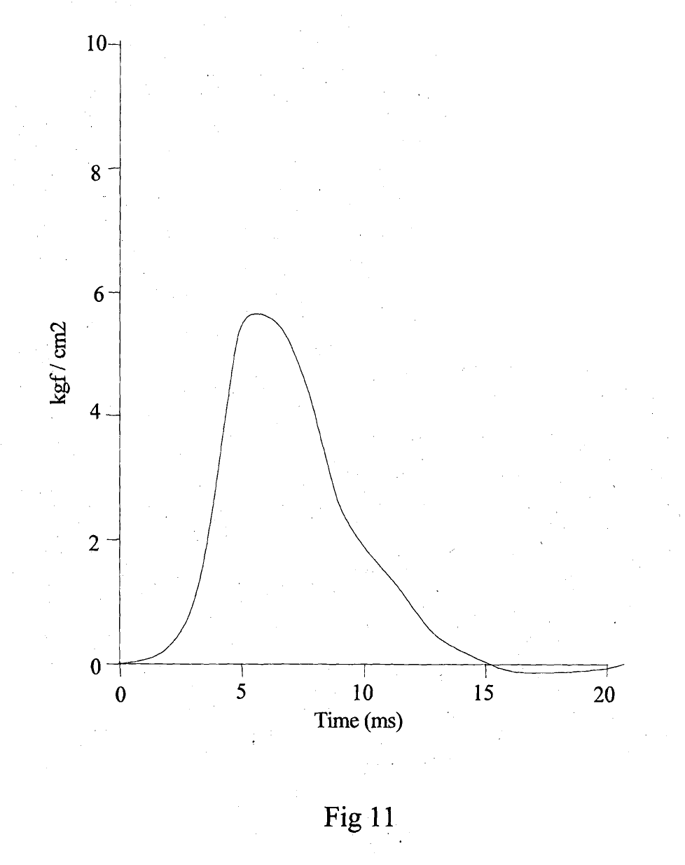

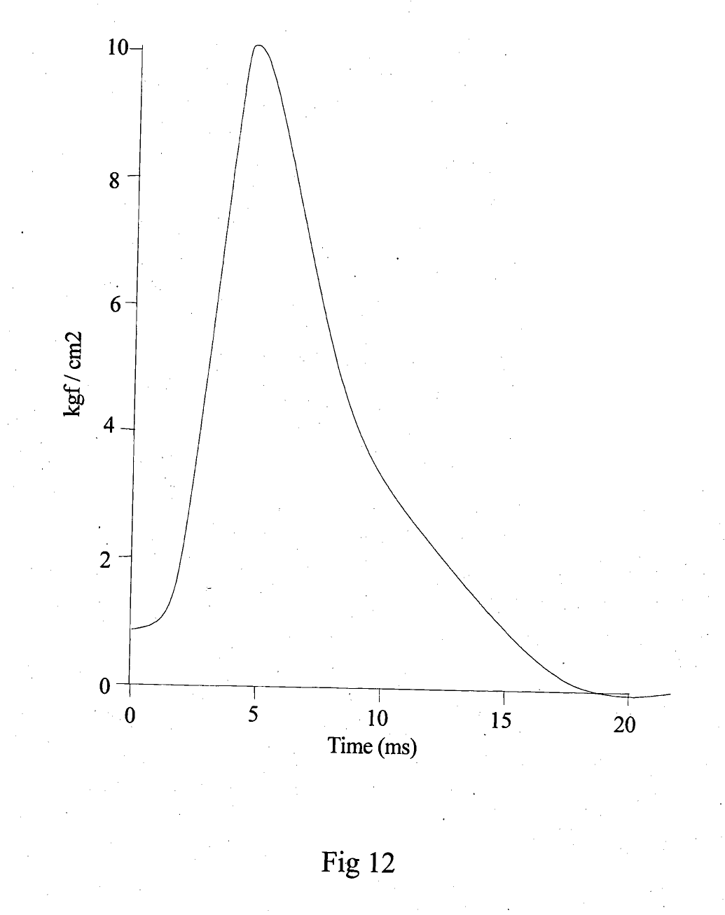

To better understand FIG. 13, it is best to first view “Power Output Vs Time” graphs shown in FIGS. 11 and 12 which each show the power output of a primary supercharged tool. These FIGS. 11 and 12 are typical representations of the prior art supercharged tools, or where only the primary supercharger is employed in tool 100 of the present embodiment. As can be seen in both of FIGS. 11 and 12, a large amount of energy is created at the beginning (first 50%) of the driving stroke as opposed to the ending (latter 50%) of the driving stroke where a greater frictional force is acting on the nail or pin.

Where a delayed secondary supercharged combustion cycle (or secondary firing cycle) is provided, a prolonged power delivery duration is achievable as demonstrated in FIG. 13.

The secondary firing cycle is further assisted by the introduction of baffle plate 139 with small holes strategically placed in the combustion chamber shroud as to interrupt or hold up the incoming secondary fresh charge of fuel/air mixture via the charge manifold 153 from the secondary supercharger 131 and or separating the new charge from the primary flame front.

Tool 100 of the present embodiment includes multiple ignition points 110A and 110B (or more than one igniter), in addition multiple applications (cycles) of the ignition points (20+) for 1 to 20 milliseconds duration are applied per tool cycle. This ensures a more complete burn in all climatic and fuel/air state conditions.

To allow these new features to operate efficiently it is important to note the function of annular smooth “aerodynamic” chamber housing 17 in conjunction with primary inlet polarity ports 134 and secondary transfer polarity ports 133, which allows the fresh incoming air flow to pass into and circulate around the combustion area and drive cylinder 13. The primary inlet ports 134 are radially spaced apart around the driving cylinder 13 near cylinder head 31, whilst secondary transfer polarity ports 133 are also radially spaced apart around the driving cylinder 13 but at a location further away from cylinder head 31 extending below housing 17.

The overall height of tool 100 is significantly reduced when compared to the prior art, firstly by utilizing an annular combustion chamber housing 17 that “bulges” outwardly a portion of combustion chamber 106 beyond the external diameter of cylinder 13. Secondly by adopting fan motor 102 to be of a “pancake type” this may also significantly reduces overall height of tool 100.

In the abovementioned first embodiment, the internal circulation fan 104 of tool 100 is driven directly by motor 102. However, in an alternative not shown “fan drive system” embodiment that can be used in tool 100, the internal circulation fan drive motor is in magnetic communication (drive) with an internal circulation fan via spaced apart magnetic drive components. Such alternative “fan drive system” would allow the fan drive motor and its associated magnetic drive component to be isolated from the combustion chamber side where internal circulation fan and its magnetic drive component are disposed. This arrangement would minimise the risk of failure to the fan drive motor due to increases in ignition pressures and/or shock within a super-charged system.

In a further not shown embodiment it should be understood that a battery charging docking station built into the tool carry case could be employed so that when the tool is placed in its home position within the case electrical contacts on the tool marry up with contacts in the case to facilitate boost or recharging of the tool battery (s). This would assist in extending battery usage. The tool carry-case may also have a solar photovoltaic panel built into the lid for the purpose of battery charging

Additionally in a further embodiment the tool is fitted with an audible and or visual information system for product (sales) tool status information for the consumer and product servicing and warranty; a touch pad may be incorporated for tool security purposes.

The terms “comprising” and “including” (and their grammatical variations) as used herein are used in inclusive sense and not in the exclusive sense of “consisting only of’.

1. A hand-held power tool, the operational power of which is provided by a gas combustion mechanism, said gas combustion mechanism comprising a first combustion chamber, a second chamber within a driving cylinder having an aft end and a fore end, said first combustion chamber in fluid communication with said second chamber via said aft end, a first supercharger including a driver assembly, a drive motor and at least one fan assembly, said driver assembly having a piston and driver movable within said driving cylinder between said aft end and said fore end, said drive motor operably connected to said driver assembly, wherein in use, whilst said piston is at or near said fore end of said driving cylinder, said fan assembly introduces air into said first combustion chamber and said second chamber thereby at least partially pressuring the air there within, fuel gas is introduced into said combustion chamber from a first fuel supply port, the air and fuel gas being mixed to form an air/fuel gas mixture therein, said drive motor operably moves said piston to a position at or near said aft end thereby compressing said air/fuel gas mixture within said first combustion chamber so that said air/fuel mixture is ignited within the combustion chamber to impart motion onto said piston and to facilitate the operation of the tool, characterized in that a second supercharger is operably connected to said combustion chamber for supplying a fuel gas and air mixture from a second supply port.

2. A hand-held power tool as claimed in claim 1, wherein both the first supercharger and second supercharger can be used in combination or independently to each other to supercharge said tool.

3. A hand-held power tool as claimed in claim 1, wherein said fuel from said second supply port is a weaker fuel than the fuel being dispensed from said first supply port.

4. A hand-held power tool as claimed in claim 1, wherein fuel from said second supercharger cylinder may be introduced into said combustion chamber after or during ignition of fuel and air mixture supercharged by said first supercharger.

5. A hand-held power tool as claimed in claim 2, wherein said tool further comprises a movable tool nose assembly and a trigger assembly both operably connected to an ECM for the control and actuation of the fan assembly, drive motor and first and second gas supply ports.

6. A hand-held power tool as claimed in claim 5, wherein said tool has a selector switch operably connected to said ECM that allows said a user to select operation of said first supercharger and second supercharger to be used in combination or independently to each other.

7. A hand-held power tool as claimed in claim 6, wherein said ECM includes a programmed timing circuit to allow variation of the supercharging provided by said second supercharger to engage and disengage said secondary supercharger and also vary the amount of supercharging from said first supercharger.

8. A hand-held power tool as claimed in claim 1, wherein said second supercharger comprises a double acting cylinder.

9. A hand-held power tool as claimed in claim 1, wherein said driving cylinder is directly connected to a cylinder head that supports said fan assembly.

10. A hand-held power tool as claimed in claim 9, wherein said driving cylinder has plurality of radially spaced apart inlet primary inlet ports around the driving cylinder near cylinder head, and a plurality of secondary transfer polarity ports radially spaced apart around said driving cylinder at a location further away from cylinder head and extending below annular chamber housing.

11. A hand-held power tool as claimed in claim 1, wherein an annular chamber housing surrounding said driving cylinder and connected thereto allows for a portion of said combustion chamber to extend radially beyond the external diameter of said driving cylinder.

12. A hand-held power tool as claimed in claim 1, wherein said fan assembly has a first external induction fan for introducing air into said first combustion chamber.

13. A hand-held power tool as claimed in claim 1, wherein said fan assembly has a fan motor which is of a pancake type.

14. A hand-held power tool as claimed in claim 1, wherein said fan assembly has a second internal circulation fan disposed within said first combustion chamber.

15. (canceled)
